(19) United States
(12) Patent Application Publication
(10) Pub. No.: US 2023/0415487 A1
(43) Pub. Date: Dec. 28, 2023

(54) RECORDING APPARATUS

(71) Applicant: SEIKO EPSON CORPORATION, Tokyo (JP)

(72) Inventors: Rikuo YAMADA, YAMAGATA-MURA (JP); Hideaki NISHIJIMA, SHIOJIRI-SHI (JP)

(21) Appl. No.: 18/339,890

(22) Filed: Jun. 22, 2023

(30) Foreign Application Priority Data
Jun. 23, 2022 (JP) 2022-100899

(51) Int. Cl. B41J 2/175; B41J 2/165; B41J 2/17

(52) U.S. Cl. CPC B41J 2/17596; B41J 2/16523; B41J 2/1721; B41J 2002/1735

(57) ABSTRACT

A recording apparatus includes a recording unit that performs recording by ejecting ink onto a medium; a pump unit that sucks a waste liquid discharged from the recording unit in a maintenance of the recording unit; a wall portion; a body in which the recording unit, the pump unit, and the wall portion are provided; and a housing in which the body is housed. The body is provided in the housing in such a way as to be changed in position between a closed position and an open position in a depth direction. The closed position is a position where the body is housed in the housing. The open position is a position where the body protrudes from the housing and where a part of the body is exposed from the housing. The wall portion is provided at a position of hiding at least a part of the pump unit exposed when the body is located at the open position.

The present application is based on, and claims priority from JP Application Serial Number 2022-100899, Jun. 23, 2022, the disclosure of which is hereby incorporated by reference herein in its entirety.

### BACKGROUND

### 1. Technical Field

The present disclosure relates to a recording apparatus.

### 2. Related Art

An ink-jet recording apparatus that is an example of a recording apparatus that performs recording on a recording sheet by using an ink-jet recording head is disclosed in JP-A-10-305572. The recording sheet is an example of a medium. It is disclosed therein that, in the ink-jet recording apparatus, a base that holds the ink-jet recording head can be moved between a position where the base is housed in a housing and a position where a part of the base housed in the housing protrudes to the outside of the housing. The base is an example of a body. It is further disclosed therein that a pump that performs processing for recovery from abnormal ink ejection status by sucking ink from the ink-jet recording head is disposed on the base. The pump is an example of a pump unit.

However, in the ink-jet recording apparatus disclosed in JP-A-10-305572, there is a risk that the pump will become exposed to the outside when at a position where a part of the base housed in the housing protrudes to the outside of the housing. Consequently, the pump will be easily accessible by the user, resulting in a risk of a problem such as ink leakage.

### SUMMARY

A recording apparatus according to an aspect of the present disclosure includes: a recording unit that performs recording by ejecting a liquid onto a medium; a pump unit that collects a waste liquid discharged from the recording unit in a maintenance of the recording unit; a wall portion; a body in which the recording unit, the pump unit, and the wall portion are provided; and a housing in which the body is housed, wherein the body is provided in the housing in such a way as to be changed in position between a closed position and an open position in a depth direction intersecting with a vertical direction, the closed position is a position where the body is housed in the housing, the open position is a position where the body protrudes from the housing and where a part of the body is exposed from the housing, and the wall portion is provided at a position of, as viewed in a width direction intersecting with the depth direction, hiding at least a part of the pump unit exposed when the body is located at the open position.

### BRIEF DESCRIPTION OF THE DRAWINGS

FIG. 1 is a perspective view illustrating a recording apparatus when a body is located at a closed position.

FIG. 2 is a perspective view illustrating the recording apparatus when the body is located at an open position.

FIG. 3 is a perspective view illustrating the recording apparatus when the body is located at an open position.

FIG. 4 is a perspective view illustrating an inner structure of the recording apparatus.

FIG. 5 is a perspective view illustrating a front surface of the recording apparatus.

FIG. 6 is a schematic sectional view taken along the line VI-VI of FIG. 5.

FIG. 7 is a perspective view illustrating the body of the recording apparatus.

FIG. 8 is a perspective view illustrating the body of the recording apparatus.

FIG. 9 is a perspective view illustrating the body of the recording apparatus.

FIG. 10 is a schematic plan view illustrating a maintenance portion.

FIG. 11 is a schematic partial side view illustrating the body of the recording apparatus.

FIG. 12 is a schematic partial side view illustrating the body of the recording apparatus.

### DESCRIPTION OF EXEMPLARY EMBODIMENTS

Based on an exemplary embodiment, the present disclosure will be presented below. In the figures, the same reference numerals are assigned to the same members, and the same explanation will not be given below. In this specification, the meaning of words “equal”, “same”, and “simultaneously” encompasses not only a case of perfect equality but also a case of being deemed as equal with a margin of measurement error considered, a case of being deemed as equal with variation in manufacturing of members considered, and a case of being deemed as equal within a range of not impairing a function. Therefore, for example, “the two have the same size” means that, with a margin of measurement error and variation in manufacturing of members considered, the difference in size between the two is within ±10%, more preferably, ±5%, still more preferably, ±3% of one of them.

In each figure, X, Y, and Z represent three spatial axes orthogonal to one another. In this specification, directions along these axes are defined as X, Y, and Z directions. When there is a need to specify its specific orientation, a plus or minus sign, “+” for a positive direction and “−” for a negative direction, will be used in combination with such axial denotation of direction. The direction indicated by an arrowhead in each figure will be described as a positive direction (+). The opposite direction will be described as a negative direction (−).

The Z-axis direction is a vertical direction, wherein +Z denotes vertically upward, and −Z denotes vertically downward. A plane including the X axis and the Y axis will be described as an X-Y plane. A plane including the X axis and the Z axis will be described as an X-Z plane. A plane including the Y axis and the Z axis will be described as a Y-Z plane. The X-Y plane is a horizontal plane. The three X, Y, and Z spatial axes will be referred to as X, Y, and Z axes when their positive/negative directional polarities are not limited.

In each figure, the Z-axis direction is a height direction of a recording apparatus 11. In the present embodiment, among lateral faces constituting the lateral enclosure of the recording apparatus 11, a lateral face on which an operation panel 33 is provided is a front surface 12 of the recording apparatus 11. The X-axis direction is a width direction of the recording apparatus 11, and is a width direction of a medium. The −X direction, one of the X-axis direction, is the direction toward the left as viewed from the user when the user stands facing the front surface 12 of the recording apparatus 11. The +X direction is the direction toward the right.

The Y-axis direction is a depth direction of the recording apparatus 11. The −Y direction, one of the Y-axis direction, is the direction from a rear surface 13 of the recording apparatus 11 toward the front surface 12 of the recording apparatus 11. The +Y direction is the direction from the front surface 12 of the recording apparatus 11 toward the rear surface 13 of the recording apparatus 11.

### 1. First Embodiment

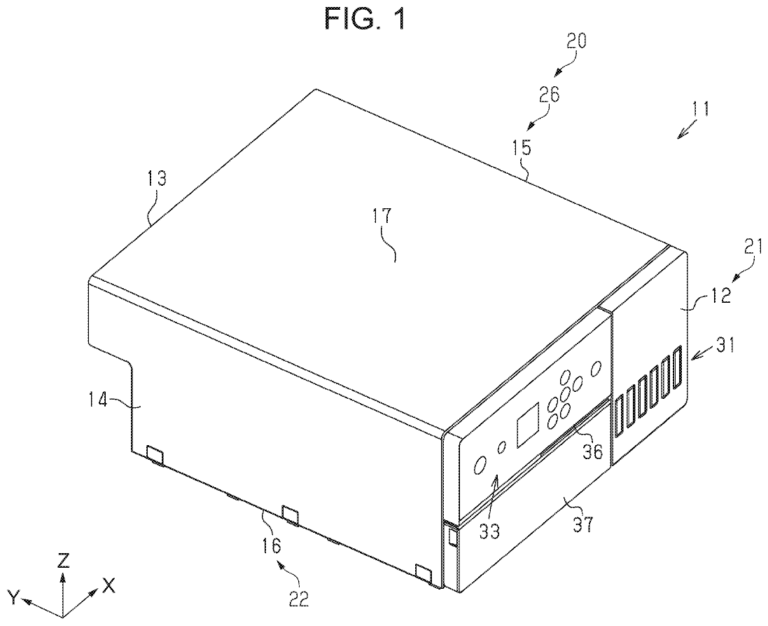

The recording apparatus 11 is, for example, an ink-jet printer that performs recording by ejecting ink from a recording unit 48 onto a medium that is transported in a transporting direction. The ink is an example of a liquid. As illustrated in FIG. 1, the recording apparatus 11 has a shape like a rectangular parallelepiped. The recording apparatus 11 has a front surface 12. The front surface 12 is a face oriented in the −Y direction. The recording apparatus 11 has a rear surface 13. The rear surface 13 is a face oriented in the +Y direction. The recording apparatus 11 has a left side surface 14. The left side surface 14 is a face oriented in the −X direction. The recording apparatus 11 has a right side surface 15. The right side surface 15 is a face oriented in the +X direction. The recording apparatus 11 has a bottom surface 16. The bottom surface 16 is a face oriented in the −Z direction. The recording apparatus 11 has a top surface 17. The top surface 17 is a face oriented in the +Z direction.

The recording apparatus 11 includes a housing 20 and a body 21. The housing 20 is configured to house the body 21. The housing 20 constitutes at least a part of the left side surface 14, a part of the right side surface 15, a part of the bottom surface 16, and a part of the top surface 17 of the recording apparatus 11. The housing 20 may constitute the whole of the left side surface 14, the whole of the right side surface 15, the whole of the bottom surface 16, and the whole of the top surface 17 of the recording apparatus 11. As described here, the housing 20 includes the left side surface 14, the right side surface 15, the bottom surface 16, and the top surface 17 of the recording apparatus 11, namely, a plurality of faces. The left side surface 14, the right side surface 15, the bottom surface 16, and the top surface 17 of the recording apparatus 11 may be said as the left side surface, the right side surface, the bottom surface, and the top surface of the housing 20 respectively. The housing 20 may include at least a part of the front surface 12 of the recording apparatus 11. The housing 20 may include at least a part of the rear surface 13 of the recording apparatus 11.

The body 21 constitutes the whole of the front surface 12 of the recording apparatus 11. The body 21 may constitute at least a part of the front surface 12 of the recording apparatus 11. As described here, the body 21 includes the front surface 12 of the recording apparatus 11. The front surface 12 of the recording apparatus 11 may be said as the front surface of the body 21. The rear surface 13 of the recording apparatus 11 may be comprised of the rear surface of the housing 20 and the rear surface of the body 21. Alternatively, the rear surface 13 of the recording apparatus 11 may be comprised of the rear surface of the housing 20 alone or the rear surface of the body 21 alone.

The body 21 is configured to be changed in position in the Y-axis direction with respect to the housing 20. The Y-axis direction is an example of a position-change direction. The −Y direction is an example of a first position-change direction. The +Y direction is an example of a second position-change direction.

The body 21 can be put into a closed position. The closed position is a position at which the body 21 is housed in the housing 20. In the present embodiment, the body 21, when at the closed position, constitutes a part of the left side surface 14, a part of the right side surface 15, a part of the bottom surface 16, and a part of the top surface 17 of the recording apparatus 11 but, alternatively, may be configured not to constitute the left side surface 14, the right side surface 15, the bottom surface 16, and the top surface 17 of the recording apparatus 11. In this case, the front surface 12 of the body 21, when at the closed position, may be located inside the housing 20.

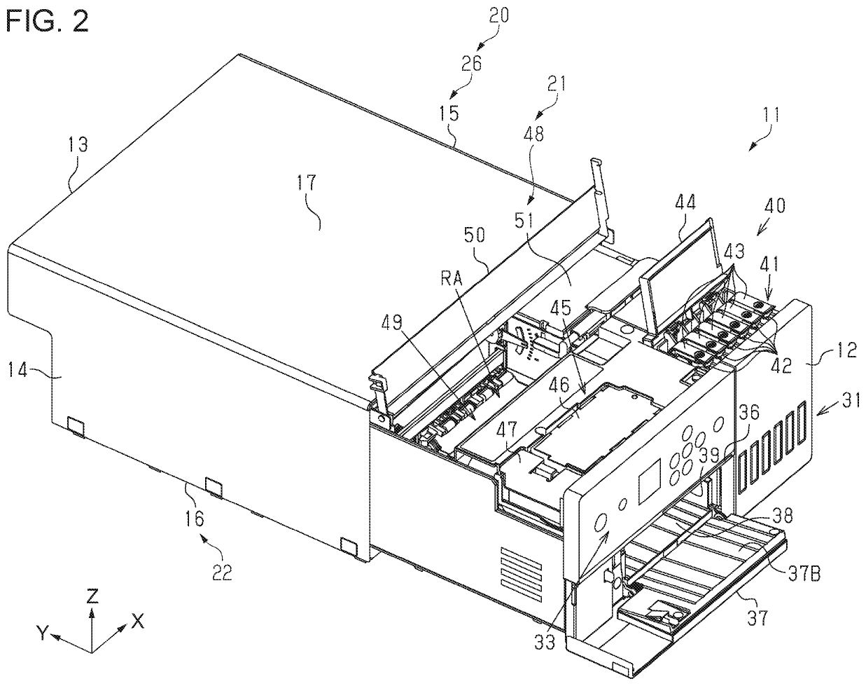

As illustrated in FIG. 2, the body 21 is configured to be changed in position to an open position. The open position is a position at which the body 21 protrudes from the housing 20 in the −Y direction. At least a part of an inner portion of the body 21 is exposed to the outside from the housing 20 when the body 21 is located at the open position. As described here, the body 21 is configured to be changed in position in the Y-axis direction between the closed position and the open position with respect to the housing 20.

As illustrated in FIGS. 1 to 3, the housing 20 includes a housing frame 26. The housing frame 26 is a member that constitutes the left side surface 14, the right side surface 15, and the top surface 17 of the recording apparatus 11. That is, the housing 20 includes a plurality of faces, which are the left side surface 14, the right side surface 15, and the top surface 17 of the recording apparatus 11.

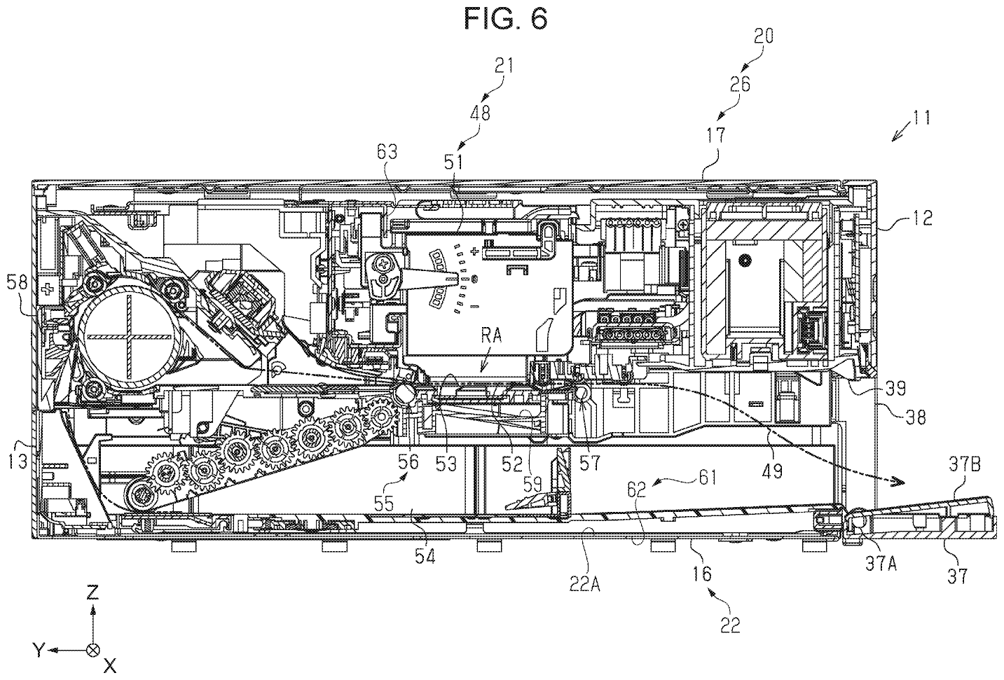

As illustrated in FIGS. 1 to 4, the housing 20 includes a bottom plate 22. The bottom plate 22 has a shape like a flat plate. The bottom plate 22 is made of metal. Alternatively, the bottom plate 22 may be made of resin, or both metal and resin. As illustrated in FIG. 6, the housing 22 has an upper surface 22A. The upper surface 22A is a surface oriented in the +Z direction. The bottom plate 22 is the bottom surface 16 of the recording apparatus 11. That is, the housing 20 includes the bottom surface 16 of the recording apparatus 11.

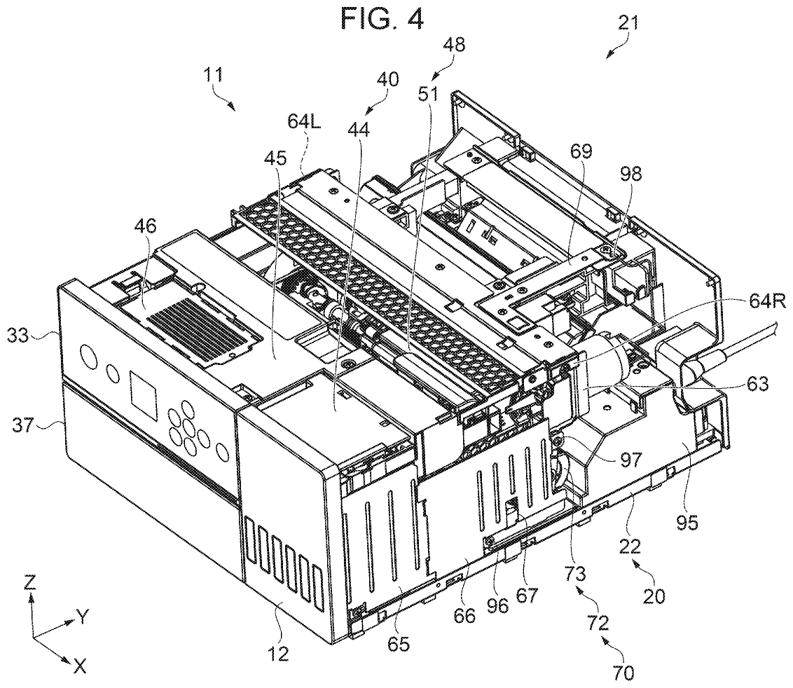

As illustrated in FIG. 4, the recording apparatus 11 includes a power unit 95. The power unit 95 converts commercial power supplied to it, and supplies power to the body 21 of the recording apparatus 11. The power unit 95 is provided in the housing 20. The power unit 95 is provided on the bottom plate 22. The power unit 95 is provided at a position closer to the rear surface 13, that is, on the +Y-directional side, than the center of the recording apparatus 11 is. A power cable can be coupled to the power unit 95 via the rear surface 13. The power unit 95 is provided along the right side surface 15 of the recording apparatus 11. In FIG. 4, the housing frame 26 of the housing 20 has been removed for the purpose of explanation.

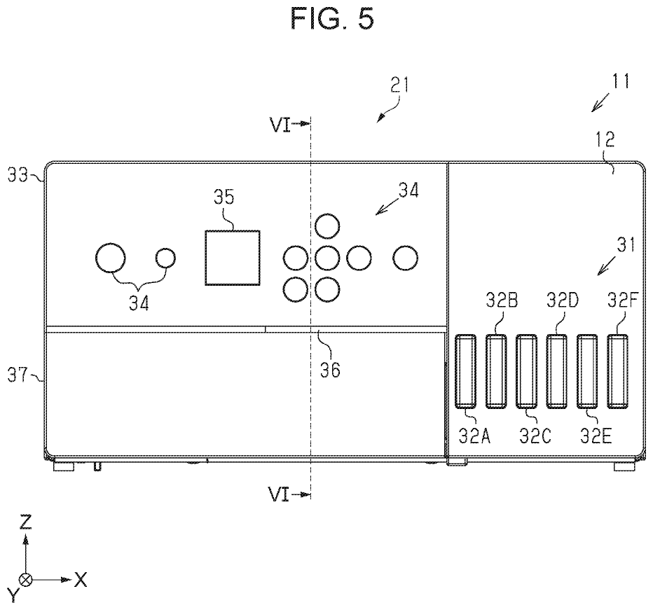

As illustrated in FIG. 5, the recording apparatus 11 includes a content amount visual confirmation portion 31. The content amount visual confirmation portion 31 is provided on the body 21. The content amount visual confirmation portion 31 makes an amount of ink contained in a liquid container portion 40 to be described later visible. The content amount visual confirmation portion 31 is comprised of a plurality of visual confirmation windows 32A, 32B, 32C, 32D, 32E, and 32F corresponding to ink of respective colors. The content amount visual confirmation portion 31 is located on the front surface 12 of the recording apparatus 11.

The recording apparatus 11 includes an operation panel 33. The operation panel 33 is provided on the body 21. The operation panel 33 includes an operation unit 34 and a display unit 35. That is, the operation unit 34 and the display unit 35 are provided on the body 21. The operation unit 34 is operable by users. The operation unit 34 is comprised of a plurality of operation buttons. The display unit 35 displays information about the recording apparatus 11. The operation panel 33 is located on the front surface 12 of the recording apparatus 11. One and the same dual-function component such as a touch panel may double as the operation unit 34 and the display unit 35.

The recording apparatus 11 includes a notification lamp 36. The notification lamp 36 is provided on the body 21. The notification lamp 36 is a lamp for notification of information about the recording apparatus 11. The notification lamp 36 may be a lamp for notification of error information about the recording apparatus 11. The notification lamp 36 is located on the front surface 12 of the recording apparatus 11. The notification lamp 36 is located on the −Z-directional side with respect to the operation panel 33, specifically, between the operation panel 33 and an open/close portion 37, which will be described below, in the Z-axis direction. The notification lamp 36 extends in the X-axis direction.

The recording apparatus 11 includes the open/close portion 37. The open/close portion 37 is provided on the body 21. The open/close portion 37 is located on the front surface 12 of the recording apparatus 11. The open/close portion 37 is located on the −Z-directional side with respect to the operation panel 33 and the notification lamp 36. As illustrated in FIG. 6, the open/close portion 37 is capable of being turned around a rotation axis 37A provided at its lower end portion and extending in the X-axis direction. Having this structure, the open/close portion 37 can be opened away from, and closed toward, the front surface 12 of the recording apparatus 11.

As illustrated in FIGS. 2 and 6, the recording apparatus 11 includes an exit port 38. The exit port 38 is provided in the body 21. The exit port 38 is an opening through which a medium after recording by a recording unit 48 to be described later goes out. The exit port 38 is open at the −Y directional face of the recording apparatus 11. That is, the exit port 38 is provided in the front surface 12 of the recording apparatus 11 as an opening oriented in the −Y direction. In other words, the exit port 38 is provided in the front surface 12 of the body 21 as an opening oriented in the −Y direction.

The exit port 38 is exposed at the −Y directional face of the recording apparatus 11 when the open/close portion 37 is open. The exit port 38 is not exposed when the open/close portion 37 is closed. Alternatively, the exit port 38 may be exposed also when the open/close portion 37 is closed. The exit port 38 is located on the −X-directional side with respect to the liquid container portion 40 to be described later.

The recording apparatus 11 includes a sheet ejection tray 37B. The sheet ejection tray 37B is provided on the body 21. The sheet ejection tray 37B is provided as an inner wall surface of the open/close portion 37. The sheet ejection tray 37B is exposed when the open/close portion 37 is open. Sheets of the medium after recording can be stacked thereon. The sheet ejection tray 37B may be configured such that it can be extended and retracted in the Y-axis direction.

The recording apparatus 11 includes a grip portion 39. The grip portion 39 is provided on the body 21. The grip portion 39 is provided on the +Z-directional side with respect to the exit port 38. The grip portion 39 is provided inside the front surface 12 of the recording apparatus 11 at a position where it can be gripped by the user from the −Y-directional side. That is, the grip portion 39 is provided inside the −Y-oriented face of the body 21 at a position where it can be gripped by the user from the −Y-directional side. As described here, the grip portion 39 can be gripped by the user when the user changes the position of the body 21 in the Y-axis direction.

As illustrated in FIG. 2, the recording apparatus 11 includes the liquid container portion 40. The liquid container portion 40 is mounted in the body 21. The liquid container portion 40 is configured to contain ink to be used for performing recording on a medium. That is, the liquid container portion 40 is configured to contain ink to be supplied to the recording unit 48 to be described later. The liquid container portion 40 according to the present embodiment is a tank-type container portion into which ink can be poured. The liquid container portion 40 is provided next to the exit port 38 and the grip portion 39 in the X-axis direction. The liquid container portion 40 is provided next to a waste-liquid-container attachment portion 45 to be described later in the X-axis direction.

The liquid container portion 40 has container spaces 41. The container spaces 41 are configured to contain ink. The liquid container portion 40 has six container spaces 41 corresponding to ink of the respective colors.

The liquid container portion 40 has liquid inlets 42. The liquid inlets 42 are openings through which ink can be poured into the container spaces 41. The liquid container portion 40 has six liquid inlets 42 corresponding to ink of the respective colors.

The liquid container portion 40 has caps 43. The caps 43 cover the liquid inlets 42. The caps 43 are capable of suppressing drying in the container spaces 41 by hermetically closing the container spaces 41. The liquid container portion 40 has six caps 43 corresponding to ink of the respective colors. Removing the cap 43 from the liquid inlet 42 enables the user to pour ink into the container space 41 through the liquid inlet 42.

The liquid container portion 40 includes a first cover portion 44. The first cover portion 44 has an openable-and-closeable structure. The container spaces 41 and the caps 43 are covered by the first cover portion 44 from the +Z-directional side when the first cover portion 44 is closed. The caps 43 are accessible to the user when the first cover portion 44 is open. As described here, the user is able to remove the cap 43 from the liquid inlet 42 when the first cover portion 44 is open.

The liquid container portion 40 is not exposed to the outside from the housing 20 when the body 21 is located at the closed position. In other words, the liquid inlets 42 are not exposed to the outside from the housing 20 when the body 21 is located at the closed position.

On the other hand, the liquid container portion 40 is exposed to the outside from the housing 20 when the body 21 is located at the open position. As described here, the liquid inlet 42 becomes exposed to the outside from the housing 20 by removing the cap 43 therefrom after opening the first cover portion 44 when the body 21 is located at the open position. This makes it possible to pour ink into the container space 41 through the liquid inlet 42.

As described above, the liquid container portion 40 is exposed to the outside from the housing 20 when the body 21 is located at the open position. In other words, the liquid inlets 42 are exposed to the outside from the housing 20 when the body 21 is located at the open position. In addition, it is possible to provide a space at the +Z-directional side with respect to the liquid container portion 40 when the body 21 is located at the open position, at which the liquid container portion 40 is exposed to the outside from the housing 20. This enhances operability, for example, makes it easier to set the container that contains the liquid in erect position in a self-supported manner, with its spout inserted in the liquid inlet 42.

As illustrated in FIGS. 2 to 4, the recording apparatus 11 includes the waste-liquid-container attachment portion 45. A waste liquid container 46 can be attached to the waste-liquid-container attachment portion 45. Ink discharged as a waste liquid from the recording unit 48 to be described later can be collected by means of a maintenance portion 70 to be described later into the waste liquid container 46.

The waste-liquid-container attachment portion 45 is provided in the body 21. The waste-liquid-container attachment portion 45 is provided on the +Z-directional side with respect to the exit port 38. The waste-liquid-container attachment portion 45 is provided next to the liquid container portion 40 in the X-axis direction.

As illustrated in FIG. 2, the waste-liquid-container attachment portion 45 includes a container fixing portion 47. The container fixing portion 47 is configured to fix the waste liquid container 46 attached to the waste-liquid-container attachment portion 45. The container fixing portion 47 can be changed in position between a position for fixing the waste liquid container 46 attached to the waste-liquid-container attachment portion 45 and a position for making the waste liquid container 46 detachable from the waste-liquid-container attachment portion 45.

The waste-liquid-container attachment portion 45 is not exposed to the outside from the housing 20 when the body 21 is located at the closed position. On the other hand, the waste-liquid-container attachment portion 45 is exposed to the outside from the housing 20 when the body 21 is located at the open position. This makes it possible to attach and detach the waste liquid container 46 to and from the waste-liquid-container attachment portion 45.

As illustrated in FIGS. 2 to 4, the recording apparatus 11 includes the recording unit 48. The recording unit 48 is configured to perform recording on a medium by ejecting ink onto the medium. The recording unit 48 is mounted in the body 21. The recording unit 48 is provided next to the liquid container portion 40 in the Y-axis direction. The recording unit 48 is provided on the +Y-directional side with respect to the liquid container portion 40.

The recording unit 48 is exposed to the outside from the housing 20 when the body 21 is located at the open position. More particularly, a carriage 51, which will be described below, of the recording unit 48 is exposed to the outside from the housing 20 when the body 21 is located at the open position. The recording unit 48 is not exposed to the outside from the housing 20 when the body 21 is located at the closed position. As illustrated in FIG. 2, when the body 21 is located at the open position, the carriage 51 is located at a standby position, which is on the +X-directional side with respect to a recording area RA to be described later.

The recording apparatus 11 includes a transportation path 49. The transportation path 49 is a path along which the medium is transported. The transportation path 49 is provided in the body 21. A part of the transportation path 49 is exposed to the outside from the housing 20 when the body 21 is located at the open position. More particularly, of the transportation path 49, the recording area RA, at which recording onto the medium is performed by the recording unit 48, is exposed to the outside from the housing 20 when the body 21 is located at the open position. The transportation path 49 is not exposed to the outside from the housing 20 when the body 21 is located at the closed position.

The recording apparatus 11 includes a second cover portion 50. The second cover portion 50 is provided on the body 21. The second cover portion 50 has an openable-and-closeable structure. The recording unit 48 and a part of the transportation path 49 are covered by the second cover portion 50 from the +Z-directional side when the second cover portion 50 is closed. A maintenance on the recording unit 48 and the part of the transportation path 49, such as removal of a jammed sheet of paper, can be performed by the user when the second cover portion 50 is open.

As illustrated in FIG. 6, the recording unit 48 includes the carriage 51 and a liquid ejecting head 52. The carriage 51 supports the liquid ejecting head 52 from the +Z-directional side. The liquid ejecting head 52 is provided on the −Z-directional side with respect to the carriage 51. The liquid ejecting head 52 is mounted on the carriage 51.

The liquid ejecting head 52 has a plurality of non-illustrated nozzles in its nozzle surface, which is the −Z-directional surface. Each of the plurality of nozzles has an opening oriented toward a medium supported by a medium supporting portion 53 to be described below. Each of the plurality of nozzles is configured to eject ink. The liquid ejecting head 52 ejects ink from the plurality of nozzles toward the medium supported by the medium supporting portion 53. As described here, the recording unit 48 is configured to perform recording on the medium by ejecting ink onto the medium. The liquid ejecting head 52 is a serial head that ejects ink while the carriage 51 moves in the X-axis direction but may be a line head.

The recording apparatus 11 includes the medium supporting portion 53. The medium supporting portion 53 is provided in the body 21. The medium supporting portion 53 is configured to support a medium. The medium supporting portion 53 supports the medium at the recording area RA, at which recording onto the medium is performed by the recording unit 48.

The recording apparatus 11 includes a second waste liquid receiver 59. When recording onto the medium is performed by ejecting ink from the recording unit 48, the second waste liquid receiver 59 receives, as a waste liquid, ink ejected from the recording unit 48 onto, of the recording area RA, an area portion located outside the medium. The second waste liquid receiver 59 is provided in the body 21. The second waste liquid receiver 59 is provided at a position that is on the −Z-directional side with respect to the medium supporting portion 53 within the recording area RA.

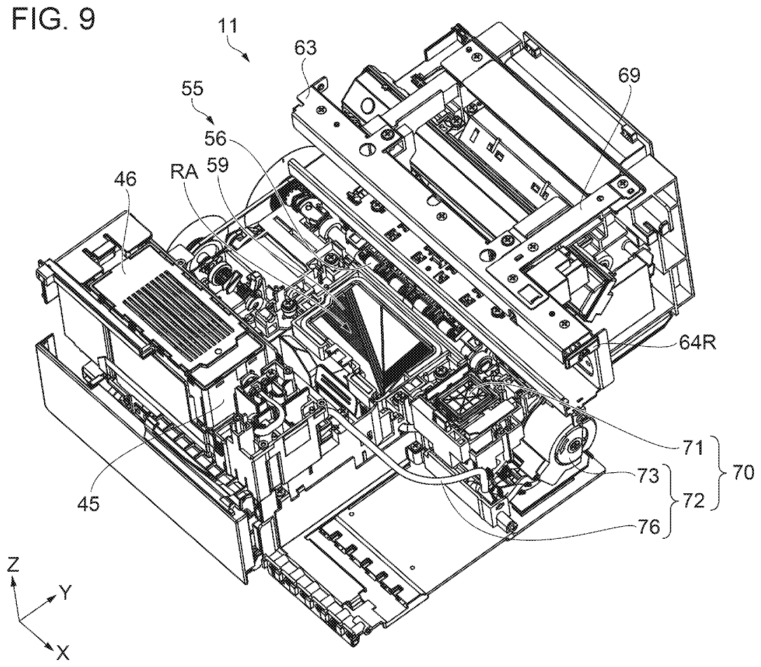

As illustrated in FIGS. 6 and 9, the second waste liquid receiver 59 has a recessed portion that is open in the +Z direction at a position that is on the −Z-directional side with respect to the medium supporting portion 53. In the recording performed by the recording unit 48, the recessed portion of the second waste liquid receiver 59 receives and collects, as a waste liquid, the ink ejected from the recording unit 48 onto, of the recording area RA, the area portion located outside the medium. In FIG. 9, the medium supporting portion 53, the carriage 51, the liquid container portion 40, a liquid-container-portion holding portion 65 to be described later, and a wall portion 66 have been removed from the body 21 for the purpose of explanation.

As illustrated in FIG. 6, the recording apparatus 11 includes a sheet feeding tray 54. The sheet feeding tray 54 is a tray on which sheets of a medium can be placed. The sheet feeding tray 54 is mounted on the body 21. The sheet feeding tray 54 can be changed in position from the body 21 in the Y-axis direction. By being drawn out of the body 21 in the Y-axis direction, the sheet feeding tray 54 is put into a state in which the medium can be placed on it and the medium can be taken out of it.

The recording apparatus 11 includes a transporting portion 55. The transporting portion 55 is configured to transport a medium. The transporting portion 55 is provided in the body 21. The transporting portion 55 feeds sheets of the medium placed on the sheet feeding tray 54 one by one. The transporting portion 55 transports the fed sheet of the medium along the transportation path 49.

The transporting portion 55 includes a plurality of rollers and a plurality of motors serving as a driving source. The transportation unit 55 includes a pair of transporting rollers 56. When the direction in which the medium is transported is defined as a transporting direction, the pair of transporting rollers 56 is located upstream of the medium supporting portion 53 in the transporting direction on the transportation path 49. The pair of transporting rollers 56 transports the medium to the medium supporting portion 53 along the transportation path 49. The transporting portion 55 includes a pair of ejecting rollers 57. The pair of ejecting rollers 57 is located downstream of the medium supporting portion 53 in the transporting direction on the transportation path 49. The pair of ejecting rollers 57 ejects the medium after recording along the transportation path 49.

The transporting portion 55 includes a reversing portion 58. The reversing portion 58 is mounted in the body 21. The reversing portion 58 is configured to be detachably attached to the body 21 from the +Y-directional side. The reversing portion 58 includes a plurality of rollers. The reversing portion 58 is configured to reverse the direction in which the medium is transported along the transportation path 49.

As illustrated in FIGS. 4 and 6, the recording apparatus 11 includes a recording-unit supporting portion 63. The recording-unit supporting portion 63 supports the recording unit 48 such that it can move in the X-axis direction. The recording-unit supporting portion 63 is provided in the body 21. The recording-unit supporting portion 63 is provided in such a way as to extend in the width direction, which is the X-axis direction, of the body 21. The recording-unit supporting portion 63 is formed of a plate member made of metal having electric conductivity, which is an example of a metal member. The recording-unit supporting portion 63 is electrically coupled to the power unit 95 via a relay member 69 having electric conductivity and a grounding connection line 98 having flexibility. By this connection, the recording-unit supporting portion 63 is grounded via the power unit 95. The recording-unit supporting portion 63 may be made up of, for example, a member that is grounded and made of metal and a member that is made of resin.

As illustrated in FIG. 4, the recording apparatus 11 includes sliding portions 64R and 64L. The sliding portion 64R, 64L is provided in such a way as to be able to slide on the housing 20 when the body 21 is changed in position in the Y-axis direction. The sliding portion 64R, 64L is provided in the body 21. The sliding portion 64R, 64L is provided at, of the recording-unit supporting portion 63, an area where it is not exposed when the body 21 is located at the closed position and when at the open position. Therefore, the sliding portion 64R, 64L is provided in such a way as to be able to slide on the housing 20 when the body 21 is changed in position between the closed position and the open position.

The sliding portion 64R, 64L is provided at the +Z-directional end of the recording-unit supporting portion 63. The sliding portion 64R is a thin plate-like member provided along the Y-axis direction at the +X-directional end of the recording-unit supporting portion 63. The +X-directional surface of the sliding portion 64R is provided at a slight distance from the inner surface of the right side surface 15 in such a way as to be able to come into contact with, of the −X-directional inner surface of the right side surface 15 of the housing 20, a position closer to the top surface 17, which is located on the +Z-directional side, than the center is. That is, the sliding portion 64R is provided in such a way as to be able to slide on the inner surface of the right side surface 15 when it is in contact with the inner surface of the right side surface 15 in the change in position of the body 21 between the closed position and the open position.

The sliding portion 64L is a thin plate-like member provided along the Y-axis direction at the −X-directional end of the recording-unit supporting portion 63. The −X-directional surface of the sliding portion 64L is provided at a slight distance from the inner surface of the left side surface 14 in such a way as to be able to come into contact with, of the +X-directional inner surface of the left side surface 14 of the housing 20, a position closer to the top surface 17, which is located on the +Z-directional side, than the center is. That is, the sliding portion 64L is provided in such a way as to be able to slide on the inner surface of the left side surface 14 when it is in contact with the inner surface of the left side surface 14 in the change in position of the body 21 between the closed position and the open position.

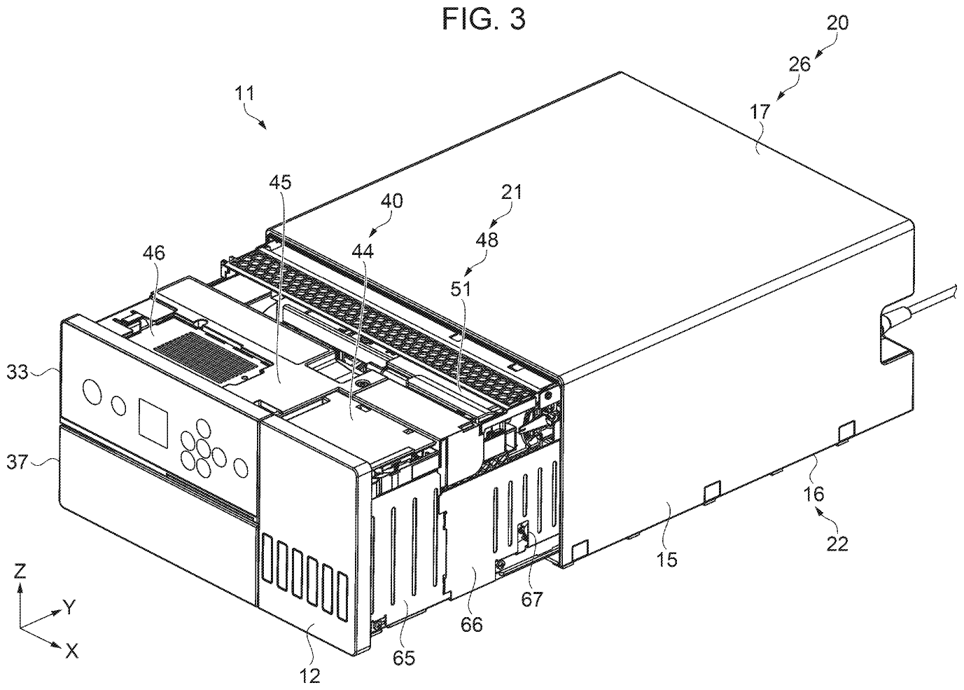

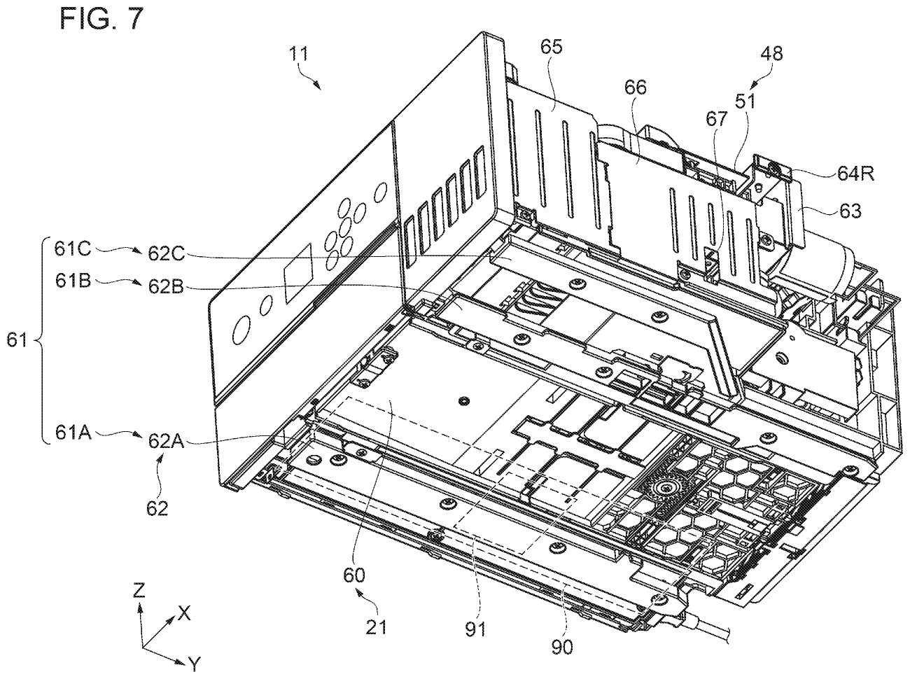

As illustrated in FIG. 4, the recording apparatus 11 includes the wall portion 66. As illustrated in FIG. 7, the wall portion 66 is provided in the body 21 in such a way as to extend in the +Z direction from a body frame 60 to be described later. As illustrated in FIG. 3, the wall portion 66 is provided at such a position that the +Y-directional end of the wall portion 66 is not exposed to the outside when the body 21 is located at the open position. In other words, of the body 21, an area portion located on the +Y-directional side with respect to the +Y-directional end of the wall portion 66 in FIG. 4 is not exposed to the outside when the body 21 is located at the open position. The wall portion 66 is provided on the −X-directional side with respect to +X-directional surface of the sliding portion 64R. The wall portion 66 is provided on the +X-directional side with respect to −X-directional surface of the sliding portion 64L.

As illustrated in FIG. 4, the wall portion 66 is provided along the Y-axis direction at a position that is on the +X-directional side with respect to the carriage 51 located at the standby position. The wall portion 66 is formed of a plate member made of metal having electric conductivity, which is an example of a metal member. The wall portion 66 is coupled to the recording-unit supporting portion 63 by means of a fastening screw 97 at a contact portion for contact with the recording-unit supporting portion 63. By this connection, the wall portion 66 is grounded via the recording-unit supporting portion 63 and the power unit 95.

The fastening screw 97 is a self-tap screw made of metal and capable of being screw-driven for fastening while producing female-screw threads in a fastening hole provided in the recording-unit supporting portion 63 by means of the own threads of the fastening screw 97. The fastening hole provided in the recording-unit supporting portion 63 is formed by burring. The fastening screw 97 is inserted into a through hole provided in the wall portion 66, and the fastening screw 97 is threadably driven into the fastening hole provided in the recording-unit supporting portion 63; as a result, the threads of the fastening screw 97 become electrically coupled to the fastening hole provided in the recording-unit supporting portion 63, and the +X-directional surface of the wall portion 66 becomes electrically coupled to the head portion of the fastening screw 97.

By this means, for example, even in a case where the wall portion 66 and the recording-unit supporting portion 63 are made of a zinc-coated steel plate having a galvanized surface, the wall portion 66 and the recording-unit supporting portion 63 are electrically coupled. The wall portion 66 may be made up of, for example, a metal member that is grounded and a member that is made of resin. In this case, the metal member of the wall portion 66 is grounded by being in contact with a grounded metal member of the recording-unit supporting portion 63.

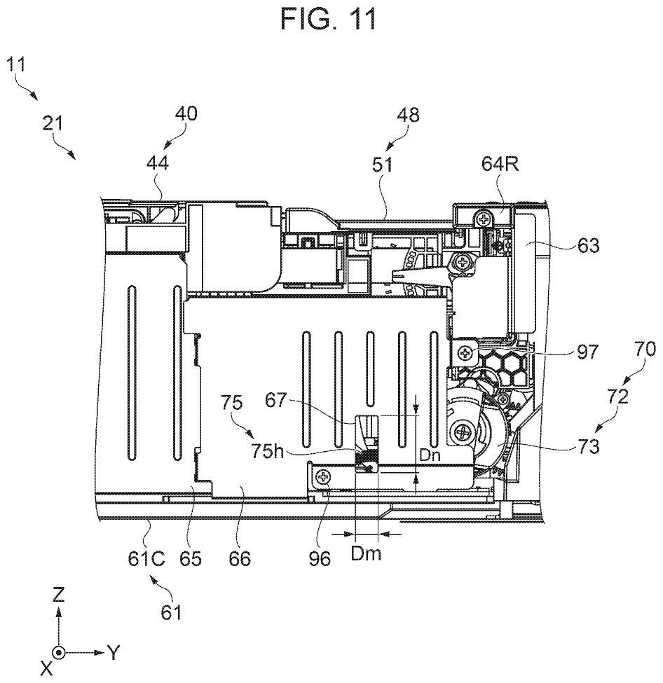

An opening 67 is provided in the wall portion 66. The opening 67 is provided at, in the wall portion 66, a position of being exposed to the outside when the body 21 is located at the open position. The opening 67 is a rectangular through hole provided at, in the wall portion 66, a position that is on the −Z-directional side with respect to the center thereof. As illustrated in FIG. 11, in the present embodiment, the opening 67 is provided in the wall portion 66 such that its longer-side direction is along the Z-axis direction and such that its shorter-side direction is along the Y-axis direction.

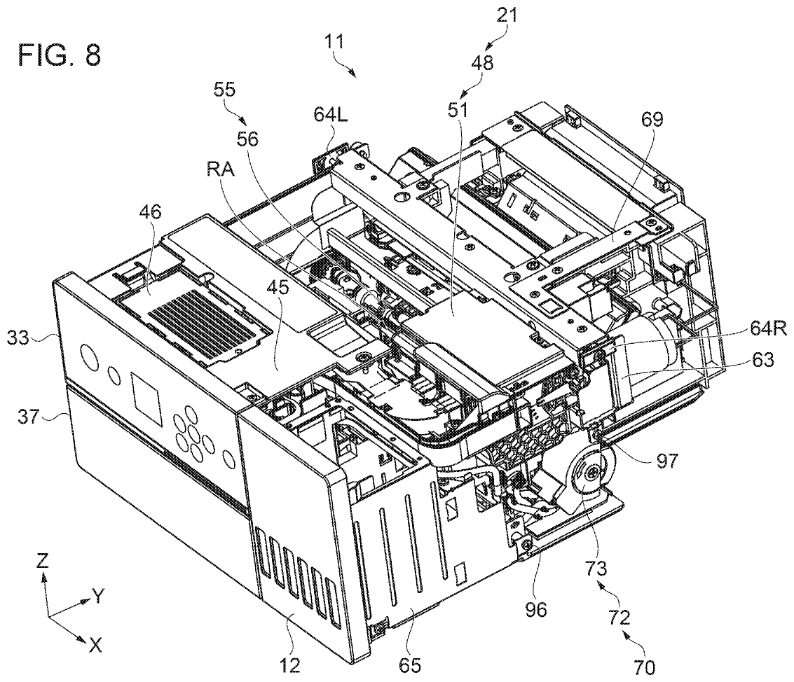

As illustrated in FIGS. 3 and 4, the recording apparatus 11 includes the liquid-container-portion holding portion 65. The liquid-container-portion holding portion 65 holds the liquid container portion 40. The liquid-container-portion holding portion 65 is provided at, in the body 21, a position of being exposed to the outside when at the open position. The liquid-container-portion holding portion 65 is formed of a plate member made of metal having electric conductivity, which is an example of a metal member. As will be understood from a comparison of FIG. 4 and FIG. 8, which illustrates the body 21 with the wall portion 66 removed, the liquid-container-portion holding portion 65 has an extending portion that is along the Y-axis direction and extends from a position next to the liquid container portion 40 to a position of overlapping with the wall portion 66, which is located on the +Y-directional side. The extending portion of the liquid-container-portion holding portion 65 is located on the −X-directional side with respect to the most +X-directional surface of the wall portion 66.

The liquid-container-portion holding portion 65 is coupled to the wall portion 66 by means of a fastening screw 96 at, of the extending portion, the +Y-directional end of being in contact with the wall portion 66. By this connection, the liquid-container-portion holding portion 65 is grounded via the wall portion 66, the recording-unit supporting portion 63, and the power unit 95.

The fastening screw 96 is a self-tap screw similar to the fastening screw 97. The fastening hole provided in the liquid-container-portion holding portion 65 is formed by burring. The fastening screw 96 is inserted into a through hole provided in the wall portion 66, and the fastening screw 96 is threadably driven into the fastening hole provided in the liquid-container-portion holding portion 65; as a result, the threads of the fastening screw 96 become electrically coupled to the fastening hole provided in the liquid-container-portion holding portion 65, and the +X-directional surface of the wall portion 66 becomes electrically coupled to the head portion of the fastening screw 96.

By this means, for example, even in a case where the liquid-container-portion holding portion 65 and the wall portion 66 are made of a zinc-coated steel plate having a galvanized surface, the liquid-container-portion holding portion 65 and the wall portion 66 are electrically coupled. The liquid-container-portion holding portion 65 may be made up of, for example, a metal member that is grounded and a member that is made of resin. In this case, the metal member of the liquid-container-portion holding portion 65 is grounded by being in contact with a grounded metal member of the wall portion 66.

As illustrated in FIG. 7, the body 21 includes the body frame 60 and a slide rail 61. The body frame 60 and the slide rail 61 are formed separately from each other. The body frame 60 is mounted on the slide rail 61. The body frame 60 is not in contact with the upper surface 22A of the bottom plate 22 of the housing 20.

The body frame 60 supports various members that constitute the body 21. That is, various members that constitute the body 21 are mounted on the body frame 60. As a specific example of them, the liquid container portion 40, the waste-liquid-container attachment portion 45, the recording unit 48, the sheet feeding tray 54, the transporting portion 55, the second waste liquid receiver 59, the recording-unit supporting portion 63, the liquid-container-portion holding portion 65, the wall portion 66, and the maintenance portion 70 are mounted on the body frame 60.

The slide rail 61 supports the body frame 60. The slide rail 61 is made of resin. As illustrated in FIG. 6, the slide rail 61 is configured to slide on the upper surface 22A of the bottom plate 22 of the housing 20. The slide rail 61 is configured to slide on the upper surface 22A of the bottom plate 22 without any contact of the body frame 60 with the upper surface 22A of the bottom plate 22.

More specifically, the slide rail 61 is configured to slide on the upper surface 22A of the bottom plate 22 of the housing 20 in a state in which a bottom surface 62 of the slide rail 61 is in contact with the upper surface 22A of the bottom plate 22 of the housing 20. That is, the body 21 is configured to be changed in position in the Y-axis direction in a state of being supported over the upper surface 22A of the bottom plate 22 of the housing 20.

As illustrated in FIG. 7, the slide rail 61 includes a plurality of slide rails 61A, 61B, and 61C. Each of the plurality of slide rails 61A, 61B, and 61C extends in the Y-axis direction. The slide rail 61B and the slide rail 61C are formed integrally with each other but may be formed separately from each other. The slide rail 61A is formed separately from the slide rail 61B and the slide rail 61C but may be formed integrally therewith.

The slide rail 61A, the slide rail 61B, and the slide rail 61C are arranged next to each other in the X-axis direction. The plural slide rails 61A, 61B, and 61C are arranged in the order of the slide rail 61A, the slide rail 61B, and the slide rail 61C in the +X direction.

The slide rail 61A is disposed at a position closer to the left side surface 14 of the recording apparatus 11 than to the right side surface 15 of the recording apparatus 11. The slide rail 61B and the slide rail 61C are disposed at a position closer to the right side surface 15 of the recording apparatus 11 than to the left side surface 14 of the recording apparatus 11.

The slide rail 61A is configured to slide on the upper surface 22A of the bottom plate 22 of the housing 20 in a state in which a bottom surface 62A of the slide rail 61A is in contact with the upper surface 22A of the bottom plate 22 of the housing 20. The slide rail 61B is configured to slide on the upper surface 22A of the bottom plate 22 of the housing 20 in a state in which a bottom surface 62B of the slide rail 61B is in contact with the upper surface 22A of the bottom plate 22 of the housing 20. The slide rail 61C is configured to slide on the upper surface 22A of the bottom plate 22 of the housing 20 in a state in which a bottom surface 62C of the slide rail 61C is in contact with the upper surface 22A of the bottom plate 22 of the housing 20.

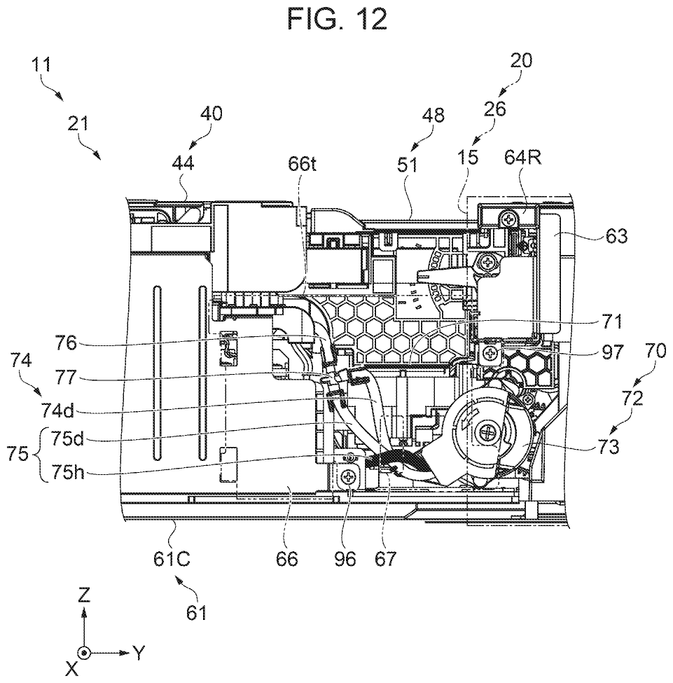

As illustrated in FIGS. 4 and 8 to 12, the recording apparatus 11 includes the maintenance portion 70. In FIG. 12, the wall portion 66 has been removed from the body 21, and the contour of the wall portion 66 is indicated by dot-dot-dash-line illustration. In addition, in FIG. 12, the position of the housing 20 when the body 21 is located at the open position is shown by the contour of the housing frame 26 indicated by dot-and-dash-line illustration.

The maintenance portion 70 performs maintenance on the liquid ejecting head 52 of the recording unit 48. The maintenance portion 70 is provided in the body 21. The maintenance portion 70 is provided between the recording area RA and the wall portion 66 in the X-axis direction. The maintenance portion 70 is provided between the liquid container portion 40 and the power unit 95 of the housing 20 in the Y-axis direction. The maintenance portion 70 includes a cap 71 and a pump unit 72.

As illustrated in FIG. 12, when the body 21 is located at the open position with removal of the wall portion 66 from the body 21, the maintenance portion 70 is exposed, and, for example, the user is able to access the maintenance portion 70 from the +X-directional side. In other words, the wall portion 66 is provided at a position where it hides at least a part of the maintenance portion 70 including the pump unit 72 as viewed in the direction along the X axis. When the body 21 is located at the open position, the +Z-directional side above the maintenance portion 70 is covered by the carriage 51 located at the standby position and by the recording-unit supporting portion 63.

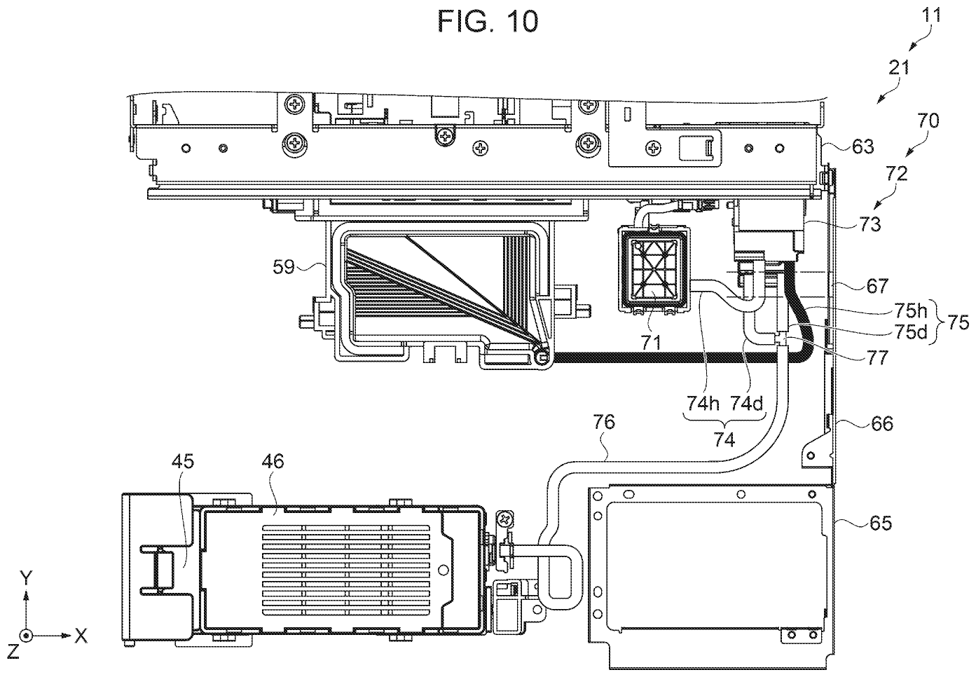

Driven by a non-illustrated cap movement mechanism, the cap 71 is configured to move between a capping position where it forms a capping space, toward which the nozzles are open, by being in contact with the nozzle surface of the liquid ejecting head 52 and a distanced position, which is located on the −Z-directional side with respect to the capping position. As illustrated in FIGS. 9 and 10, the cap 71 has a recessed portion open in the +Z direction and forming the capping space when at the capping position. A porous member configured to retain ink is provided in the recessed portion of the cap 71. As illustrated in FIG. 12, the cap 71 is provided at a position where it is hidden by the wall portion 66 as viewed in the direction along the X axis.

The maintenance portion 70 performs capping by movement of its cap 71 to the capping position when recording operation is not performed by the recording unit 48. By performing the capping, the maintenance portion 70 suppresses evaporation of solvent components of ink from the nozzles of the liquid ejecting head 52 and adhesion of foreign objects to the nozzle surface, thereby performing maintenance on the liquid ejecting head 52.

In addition, when flushing, in which ink is ejected from the nozzles of the liquid ejecting head 52, is performed for the purpose of a maintenance on the liquid ejecting head 52, the maintenance portion 70 causes the cap 71 to move to a position between the capping position and the distanced position so that the ink discharged as a waste liquid by the flushing will be collected into the cap 71. The flushing is operation of ejecting ink from the nozzles of the liquid ejecting head 52 at a timing different from that of ink ejection for recording, thereby discharging any of foreign objects, air bubbles, and thickened ink that are present inside the liquid ejecting head 52 and might cause poor ejection.

Moreover, the maintenance portion 70 performs suction cleaning of discharging ink from the nozzles by causing negative pressure to act on the nozzles via the pump unit 72 in a state in which the cap 71 is located at the capping position. The maintenance portion 70 performs the suction cleaning to discharge any of foreign objects, air bubbles, and thickened ink that are present inside the liquid ejecting head 52 and inside supply flow passages providing connection between the liquid ejecting head 52 and the liquid container portion 40, thereby performing maintenance on the liquid ejecting head 52 and the supply flow passages.

The pump unit 72 collects the waste liquid discharged from the recording unit 48 in the maintenance of the recording unit 48. The pump unit 72 includes a suction pump 73 and a tube T. As illustrated in FIG. 12, the suction pump 73 is provided at a position where a part of it is hidden by the wall portion 66 as viewed in the direction along the X axis. The suction pump 73 according to the present embodiment is a so-called tube pump that sucks ink into the tube T and discharges the ink out of the tube T by rotating on its axial center in a state in which the tube T is compressed by a roller. The tube T includes a first tube 74 and a second tube 75 that are illustrated in FIG. 10. As illustrated in FIG. 10, the pump unit 72 includes a waste liquid tube 76 and a tube joint 77.

As illustrated in FIG. 10, the first tube 74 provides connection between the cap 71 and the tube joint 77. The first tube 74 includes a first flowing-in portion 74h, through which, by driving of the suction pump 73, ink received by the cap 71 flows toward the suction pump 73, and a first flowing-out portion 74d, through which the ink flows from the suction pump 73 toward the tube joint 77. The cap 71 is an example of a first waste liquid receiver.

The second tube 75 provides connection between the second waste liquid receiver 59 and the tube joint 77. The second tube 75 includes a second flowing-in portion 75h, through which, by driving of the suction pump 73, ink received by the second waste liquid receiver 59 flows toward the suction pump 73, and a second flowing-out portion 75d, through which the ink flows from the suction pump 73 toward the tube joint 77.

In FIG. 10, each of the +Y-directional edge position and the −Y-directional edge position of the opening 67 in the Y-axis direction is indicated by a dot-dot-dash line. Between these two dot-dot-dash lines, the second tube 75 is located between the wall portion 66 and the first tube 74 in the X-axis direction. In addition, between these two dot-dot-dash lines, the first flowing-in portion 74h, the first flowing-out portion 74d, the second flowing-in portion 75h, and the second flowing-out portion 75d are provided along the Y-axis direction.

Moreover, between these two dot-dot-dash lines, the first flowing-in portion 74h, the first flowing-out portion 74d, the second flowing-in portion 75h, and the second flowing-out portion 75d are arranged in the order of the second flowing-in portion 75h, the second flowing-out portion 75d, the first flowing-in portion 74h, and the first flowing-out portion 74d as viewed in the −X direction from the wall portion 66. In this case, the second flowing-in portion 75h of the second tube 75 is provided next to the wall portion 66 in the X-axis direction. Moreover, as illustrated in FIG. 12, the wall portion 66 is provided at a position where it hides at least a part of the first tube 74 and the second tube 75 constituting the pump unit 72 as viewed in the direction along the X axis.

Moreover, as illustrated in FIG. 11, when viewed in the direction along the X axis from the +X-directional side of the wall portion 66, the second flowing-in portion 75h of the second tube 75 is visible through the opening 67. In other words, of the second tube 75, an area portion located inside the opening 67 as viewed in the direction along the X axis is provided next to the wall portion 66 in the X-axis direction. Furthermore, of the second flowing-in portion 75h of the second tube 75, an area portion located inside the opening 67 as viewed in the direction along the X axis extends substantially along the Y-axis direction.

For example, a tool for pinching and closing the second tube 75, a so-called pair of tube forceps, is inserted through the opening 67 in the processes of manufacturing the recording apparatus 11 and at the time of maintenance performed by the maintenance portion 70. For this reason, for easier insertion of the pair of tube forceps, for easier grasping of the second tube 75 between the tube forceps, and with ease of the user's accessing the maintenance portion 70 including the pump unit 72 and other factors considered, the opening 67 is provided in the wall portion 66 such that its longer-side direction is along the Z-axis direction and such that its shorter-side direction is along the Y-axis direction. That is, the opening 67 is provided in the wall portion 66 at a position of overlapping with the second tube 75 as viewed in the direction along the X axis and in an orientation in which the longer-side direction of the opening 67 intersects with the direction in which the second tube 75 extends. In the present embodiment, for example, the size Dn of the opening 67 in the longer-side direction is set to be 25 mm and the size Dm thereof in the shorter-side direction is set to be 10 mm.

As illustrated in FIGS. 10 and 12, the tube joint 77 is a so-called three-pronged joint to which three tubes can be coupled. The first flowing-out portion 74d of the first tube 74, the second flowing-out portion 75d of the second tube 75, and the waste liquid tube 76 are coupled to the tube joint 77, and this enables the ink received by the cap 71 and the ink received by the second waste liquid receiver 59 to be collected via the waste liquid tube 76 into the waste liquid container 46 attached to the waste-liquid-container attachment portion 45.

For example, when the body 21 is located at the open position with removal of the wall portion 66 from the body 21, the tube joint 77 is exposed, and, for example, the user is able to access the tube joint 77 from the +X-directional side. In the present embodiment, as illustrated in FIG. 12, a top edge 66t, which is the +Z-directional edge, of the wall portion 66 is located on the +Z-directional side, which is above the tube joint 77. In other words, the wall portion 66 is provided at a position where it hides the tube joint 77, which is a component of the pump unit 72, as viewed in the direction along the X axis. Therefore, the tube joint 77 is not exposed when the body 21 is located at the open position. For this reason, for example, it is possible to prevent the user from accessing the tube joint 77 from the +X-directional side. The tube joint 77 is an example of a coupler.

As illustrated in FIGS. 9, 10, and 12, the waste liquid tube 76 provides connection between the tube joint 77 and an inlet provided on the waste-liquid-container attachment portion 45. Ink flows through the inlet into the waste liquid container 46 attached to the waste-liquid-container attachment portion 45. Therefore, by driving of the suction pump 73, the ink received by the cap 71 is collected through the first tube 74, the tube joint 77, the waste liquid tube 76, and the inlet into the waste liquid container 46 as a waste liquid. In addition, by driving of the suction pump 73, the ink received by the second waste liquid receiver 59 is collected through the second tube 75, the tube joint 77, the waste liquid tube 76, and the inlet into the waste liquid container 46 as a waste liquid. As illustrated in FIG. 12, the waste liquid tube 76 is provided at a position where a part of it is hidden by the wall portion 66 as viewed in the direction along the X axis.

As illustrated in FIG. 7, the recording apparatus 11 includes a circuit board 90. The circuit board 90 is provided in the body 21. A control unit 91 is provided on the circuit board 90. The control unit 91 includes a non-illustrated central processing unit (CPU) and a non-illustrated memory. The CPU is capable of running various programs stored in the memory, and, for example, is capable of making various kinds of determination and giving various instructions. Various programs such as, for example, a program for transporting a medium and a program regarding a display method of displaying the status of the recording apparatus 11 on the display unit 35 of the operation panel 33 are stored in the memory. In addition, various tables of setting values to be used for calculating an amount of the waste liquid contained in the waste liquid container 46, various counter values, and the like are stored in the memory.

The control unit 91 controls the entire operation of the recording apparatus 11. For example, when recording is performed on a medium, the control unit 91 controls the recording unit 48 and the transporting portion 55 and cause them to execute the recording by ejecting ink from the nozzles of the liquid ejecting head 52 onto the medium transported on the medium supporting portion 53. In addition, for example, the control unit 91 performs maintenance on the liquid ejecting head 52 of the recording unit 48 by controlling either the cap movement mechanism or the suction pump 73 of the maintenance portion 70. Moreover, the control unit 91 causes the operation panel 33 to display information about the status of the recording apparatus 11 on the display unit 35.

As described above, the following effects can be obtained from the recording apparatus 11 according to the first embodiment.

A recording apparatus 11 includes: a recording unit 48 that performs recording by ejecting ink onto a medium; a pump unit 72 that collects a waste liquid discharged from the recording unit 48 in a maintenance of the recording unit 48; a wall portion 66; a body 21 in which the recording unit 48, the pump unit 72, and the wall portion 66 are provided; and a housing 20 in which the body 21 is housed. The body 21 is provided in the housing 20 in such a way as to be changed in position between a closed position and an open position in a Y-axis direction intersecting with a Z-axis direction. The closed position is a position where the body 21 is housed in the housing 20. The open position is a position where the body 21 protrudes from the housing 20 and where a part of the body 21 is exposed from the housing 20. The wall portion 66 is provided at a position of, as viewed in a direction along the X axis, hiding at least a part of the pump unit 72 exposed when the body 21 is located at the open position. With this structure, it is possible to prevent the user from touching the pump unit 72. Therefore, it is possible to prevent the occurrence of a problem such as the leakage of the waste liquid.

The recording apparatus 11 further includes, in its body 21, a recording-unit supporting portion 63 that supports the recording unit 48. The recording-unit supporting portion 63 includes a metal member that is grounded. The wall portion 66 includes a metal member that is in contact with the metal member of the recording-unit supporting portion 63. With this structure, it is possible to prevent the wall portion 66 that is exposed by movement of the body 21 from being charged.

The body 21 includes, at a position of becoming exposed when at the open position, a liquid-container-portion holding portion 65 that holds a liquid container portion 40 that contains the ink. The liquid-container-portion holding portion 65 includes a metal member that is in contact with the metal member of the wall portion 66. With this structure, it is possible to prevent the liquid-container-portion holding portion 65 that is exposed by movement of the body 21 from being charged.

The pump unit 72 includes a tube T through which the waste liquid flows. The wall portion 66 has an opening 67 at a position of overlapping with at least a part of the pump unit 72 as viewed in the direction along the X axis intersecting with the Y-axis direction. The opening 67 is located at a position of overlapping with the tube T as viewed in the direction along the X axis. With this structure, it is possible to prevent the user from touching the pump unit 72 while making it possible to perform maintenance on the pump unit 72 by making it easier to access the tube T through the opening 67.

The tube T includes a first tube 74 coupled to a cap 71 that receives the waste liquid when the maintenance of the recording unit 48 is performed and a second tube 75 coupled to a second waste liquid receiver 59 that receives the waste liquid when the recording is performed. The first tube 74 and the second tube 75 are coupled by a tube joint 77. The wall portion 66 extends from the body 21 in a +Z direction. A top edge 66t of the wall portion 66 is on a +Z-directional side with respect to the tube joint 77. With this structure, it is possible to prevent the user from touching the tube joint 77. Therefore, it is possible to prevent the occurrence of a problem such as the leakage of the waste liquid.

The tube T includes a first tube 74 coupled to a cap 71 that receives the waste liquid when the maintenance of the recording unit 48 is performed and a second tube 75 coupled to a second waste liquid receiver 59 that receives the waste liquid when the recording is performed. Of the second tube 75, an area portion located inside the opening 67 as viewed in the direction along the X axis is provided next to the wall portion 66 in the X-axis direction. With this structure, it is possible to prevent the user from touching the maintenance portion 70 while making it possible to discharge the waste liquid from the pump unit 72 in a state in which the second tube 75 is closed by means of a tool or the like by making it easier to access the second tube 75 through the opening 67.

The tube T includes a first tube 74 coupled to a cap 71 that receives the waste liquid when the maintenance of the recording unit 48 is performed and a second tube 75 coupled to a second waste liquid receiver 59 that receives the waste liquid when the recording is performed. The opening 67 is provided in the wall portion 66 at a position of overlapping with the second tube 75 as viewed in the direction along the X axis and in an orientation in which a longer-side direction of the opening 67 intersects with a direction in which the second tube 75 extends. With this structure, it is possible to make it easier to close the second tube 75 by means of a tool or the like and prevent the user from touching the maintenance portion 70.

The body 21 includes a sliding portion 64R, 64L configured to slide on the housing 20 when changed in position in the Y-axis direction. This structure makes it easier to change the position of the body 21 in the Y-axis direction.

Although the recording apparatus 11 according to the foregoing embodiment of the present disclosure has basically the structure described above, of course, partial changes in structure, omission, etc. can be made within a range of not departing from the gist of the present disclosure. The foregoing embodiment and other embodiments described below may be combined with one another as long as they are not technically contradictory to one another. Other embodiments will now be explained.

In the foregoing embodiment, the opening 67 of the wall portion 66 does not necessarily have to be a rectangular through hole, as long as a tool, etc. for putting the second tube 75 into a closed state can be inserted through it. For example, the opening 67 may be a round through hole, an elliptical through hole, or a polygonal through hole such as a triangular through hole.

In the foregoing embodiment, of the second flowing-in portion 75h of the second tube 75, an area portion located inside the opening 67 as viewed in the direction along the X axis does not necessarily have to extend along the Y-axis direction. For example, it may extend along the Z-axis direction, or in an oblique direction intersecting with the Y-axis direction and the Z-axis direction.

In the foregoing embodiment, the maintenance portion 70 may include an on-off valve configured to switch the second flowing-in portion 75h of the second tube 75 between a closed state and an open state, for example, an on-off valve configured to switch it between a closed state and an open state with a screwdriver. In this case, the opening 67 of the wall portion 66 may have any size as long as it is large enough for insertion of the screwdriver. For example, the opening 67 of the wall portion 66 may be a round through hole having a diameter of 5 mm.

In the foregoing embodiment, the wall portion 66 does not necessarily have to have the opening 67. In this case, for example, a through hole through which a tool, etc. for putting the second tube 75 into a closed state can be inserted may be provided in the body frame 60 of the body 21 at a position located on the −Z-directional side with respect to the second flowing-in portion 75h of the second tube 75.

In the foregoing embodiment, the wall portion 66 does not necessarily have to be grounded via the recording-unit supporting portion 63. For example, the wall portion 66 may be grounded by coupling the wall portion 66 and the power unit 95 by using a different grounding member as done via the recording-unit supporting portion 63.

In the foregoing embodiment, the liquid-container-portion holding portion 65 does not necessarily have to be grounded via the wall portion 66. For example, the liquid-container-portion holding portion 65 may be grounded by coupling the liquid-container-portion holding portion 65 and the power unit 95 by using a different grounding member as done via the recording-unit supporting portion 63.

What is claimed is:

1. A recording apparatus, comprising:
a recording unit that performs recording by ejecting a liquid onto a medium;
a pump unit that collects a waste liquid discharged from the recording unit in a maintenance of the recording unit;
a wall portion;
a body in which the recording unit, the pump unit, and the wall portion are provided; and
a housing in which the body is housed, wherein
the body is provided in the housing in such a way as to be changed in position between a closed position and an open position in a depth direction intersecting with a vertical direction,
the closed position is a position where the body is housed in the housing,
the open position is a position where the body protrudes from the housing and where a part of the body is exposed from the housing, and
the wall portion is provided at a position of, as viewed in a width direction intersecting with the depth direction, hiding at least a part of the pump unit exposed when the body is located at the open position.

2. The recording apparatus according to claim 1, further comprising in the body:
a recording-unit supporting portion that supports the recording unit and includes a metal member that is grounded, wherein
the wall portion includes a metal member that is in contact with the metal member of the recording-unit supporting portion.

3. The recording apparatus according to claim 2, wherein
the body includes, at a position of becoming exposed when at the open position, a liquid-container-portion holding portion that holds a liquid container portion that contains the liquid, and
the liquid-container-portion holding portion includes a metal member that is in contact with the metal member of the wall portion.

4. The recording apparatus according to claim 1, wherein
the pump unit includes a tube through which the waste liquid flows,
the wall portion has an opening at a position of overlapping with at least a part of the pump unit as viewed in the width direction intersecting with the depth direction, and
the opening is located at a position of overlapping with the tube as viewed in the width direction.

5. The recording apparatus according to claim 4, wherein
the tube includes a first tube coupled to a first waste liquid receiver that receives the waste liquid when the maintenance of the recording unit is performed and a second tube coupled to a second waste liquid receiver that receives the waste liquid when the recording is performed,
the first tube and the second tube are coupled by a coupler,
the wall portion extends from the body upward, and
a top edge of the wall portion is located above the coupler.

6. The recording apparatus according to claim 4, wherein
the tube includes a first tube coupled to a first waste liquid receiver that receives the waste liquid when the maintenance of the recording unit is performed and a second tube coupled to a second waste liquid receiver that receives the waste liquid when the recording is performed, and
of the second tube, an area portion located inside the opening as viewed in the width direction is provided next to the wall portion in the width direction.

7. The recording apparatus according to claim 4, wherein
the tube includes a first tube coupled to a first waste liquid receiver that receives the waste liquid when the maintenance of the recording unit is performed and a second tube coupled to a second waste liquid receiver that receives the waste liquid when the recording is performed, and
the opening is provided in the wall portion at a position of overlapping with the second tube as viewed in the width direction and in an orientation in which a longer-side direction of the opening intersects with a direction in which the second tube extends.

8. The recording apparatus according to claim 1, wherein
the body includes a sliding portion configured to slide on the housing when changed in position in the depth direction.
